(19) United States
(12) Patent Application Publication
(10) Pub. No.: US 2019/0196551 A1
(43) Pub. Date: Jun. 27, 2019

(54) PORTABLE ELECTRONIC APPARATUS

(71) Applicant: Chicony Electronics Co., LTD., New Taipei City (TW)

(72) Inventors: Yi-Hung WANG, New Taipei City (TW); Tsung-Min CHEN, New Taipei City (TW); Ming-Cheng YANG, New Taipei City (TW)

(21) Appl. No.: 16/026,593

(22) Filed: Jul. 3, 2018

Related U.S. Application Data
(60) Provisional application No. 62/610,411, filed on Dec. 26, 2017.

(51) Int. Cl. G06F 1/16; F21V 33/00; H01R 33/74; H01R 13/08; H01R 13/635; H01H 13/81; H01H 13/86

(52) U.S. Cl. CPC G06F 1/1669; G06F 1/1662; F21V 33/0052; G06F 1/1698; H01R 33/74; H01H 13/7006; H01R 13/635; H01H 13/81; H01H 13/86; G06F 1/1616; H01R 2201/06; H01R 13/08

(57) ABSTRACT

The present invention discloses a portable electronic apparatus, which includes a cover casing, a base casing, a first keyboard and a second keyboard. The base casing is pivoted to the cover casing. The base casing includes a keyboard containing portion and a first connecting portion, and the first connecting portion is disposed on the keyboard containing portion. The first keyboard and the second keyboard are disposed in the keyboard containing portion interchangeably, the first keyboard has a second connecting portion, and the second keyboard has a third connecting portion. When the first keyboard is disposed in the keyboard containing portion, the second connecting portion is electrically connected to the first connecting portion. When the second keyboard is disposed in the keyboard containing portion, the third connecting portion is electrically connected to the first connecting portion.

### BACKGROUND OF THE INVENTION

### 1. Field of the Invention

The present invention relates to a portable electronic apparatus, and more particularly, to a portable electronic apparatus with interchangeable keyboards.

### 2. Description of the Related Art

With the development of e-sports industry, there are various input modules designed specifically for e-sports such as keyboards and mice. Take gaming-specific e-sports keyboards as an example, compared with the general keyboards used for general document processing or other office applications, the main appeals of e-sports keyboards include nice typing feels when pressing the keys, rapid signal transmissions, the addition of new keys for special functions, and anti-ghost keys and other effects to help the player operate the keyboard more swiftly and conveniently.

Presently, game players still use desktop computers and gaming keyboards to play games. To enhance portability, notebook computers specially designed for e-sports are also available on the market. They are equipped with mechanical keyboards to satisfy the player's typing feeling when playing an e-sports game. However, compared with the keys of the membrane keyboards used in a general notebook computer, the keys of the mechanical keyboards used in a gaming keyboard have longer pressing stroke and therefore require a larger mechanical space for accommodation, which makes the notebook computer bulky and less convenient to carry. Therefore, in view of market requirements, there is still room for improvement for gaming keyboards used in notebook computers.

### SUMMARY OF THE INVENTION

In view of the above problems, the main object of the present invention is to provide a portable electronic apparatus which is designed with two keyboards (that is, a first keyboard and a second keyboard), wherein the first keyboard and the second keyboard can be interchangeably disposed in a keyboard containing portion of a base casing of the notebook computer, thereby solving the problem that the gaming keyboard occupies a large mechanical space, which makes the notebook computer bulky and less convenient to carry.

To achieve the above object, the present invention provides a portable electronic apparatus comprising a cover casing, a base casing, a first keyboard and a second keyboard. The base casing is pivoted to the cover casing, the base casing comprises a keyboard containing portion and a first connecting portion, wherein the first connecting portion is disposed in the keyboard containing portion. The first keyboard and the second keyboard are disposed in the keyboard containing portion interchangeably, the first keyboard has a second connecting portion, and the second keyboard has a third connecting portion. When the first keyboard is disposed in the keyboard containing portion, the second connecting portion is electrically connected to the first connecting portion, when the second keyboard is disposed in the keyboard containing portion, the third connecting portion is electrically connected to the first connecting portion.

According to an embodiment of the present invention, the second connecting portion is the same member as the third connecting portion.

According to an embodiment of the present invention, the first connecting portion, the second connecting portion and the third connecting portion are respectively pogo pin connectors.

According to an embodiment of the present invention, the first connecting portion has a single pin type spring; the second connecting portion and the third connecting portion each have a metal spring plate.

According to an embodiment of the present invention, the second connecting portion and the third connecting portion each comprise a power pin, a ground pin, a plurality of data pins, a plurality of input pins, and a detection pin.

According to an embodiment of the present invention, the base casing further comprises an eject switch, when a force is applied on the eject switch, the eject switch ejects the first keyboard or the second keyboard from the keyboard containing portion.

According to an embodiment of the present invention, the first keyboard and the second keyboard each comprise an eject switch, when a force is applied on the eject switch, the eject switch ejects the first keyboard or the second keyboard from the keyboard containing portion.

According to an embodiment of the present invention, the portable electronic apparatus further comprises an expansion element. The expansion element comprises a sub keyboard containing portion and a fourth connecting portion, wherein the fourth connecting portion is disposed in the sub keyboard containing portion, and the first keyboard and the second keyboard are disposed in the sub keyboard containing portion interchangeably. When the first keyboard is disposed in the sub keyboard containing portion, and the second connecting portion is electrically connected to the fourth connecting portion. When the second keyboard is disposed in the sub keyboard containing portion, the third connecting portion is electrically connected to the fourth connecting portion.

According to an embodiment of the present invention, the first connecting portion is the same member as the fourth connecting portion.

According to an embodiment of the present invention, the first keyboard is a membrane keyboard, and the second keyboard is a gaming mechanical keyboard.

According to an embodiment of the present invention, the first connecting portion, the second connecting portion and the third connecting portion are consisted of a universal serial bus (USB) and an inter-integrated circuit (I²C).

According to an embodiment of the present invention, the second keyboard comprises keys having a plurality of lighting units, and the plurality of lighting units can be controlled by the universal serial bus (USB) or the inter-integrated circuit (I²C).

According to an embodiment of the present invention, the base casing is provided with a first wireless transmission module, the first keyboard or the second keyboard is provided with a second wireless transmission module. When the second connecting portion or the third connecting portion is electrically connected to the first connecting portion, the second connecting portion or the third connecting portion is used for communicating with the first connecting portion. When the second connecting portion or the third connecting portion is electrically separated from the first connecting portion, the first wireless transmission module is used for communicating with the second wireless transmission module.

According to an embodiment of the present invention, the first keyboard or the second keyboard is provided with a battery, when the second connection portion or the third connection portion is electrically separated from the first connection portion, the battery is used for providing power to the first keyboard or the second keyboard.

As described above, the portable electronic apparatus according to the present invention comprises the first keyboard and the second keyboard, and the base casing of the portable electronic apparatus comprises the keyboard containing portion and the first connecting portion, for the first keyboard and the second keyboard to be disposed in the keyboard containing portion interchangeable to perform different functions respectively, thereby allowing the portable electronic apparatus to provide various types of keyboard inputs, and to be applied to different purposes. For example, when the first keyboard is disposed in the keyboard containing portion, the second connecting portion of the first keyboard is electrically connected to the first connecting portion so that the user can use the first keyboard to perform document processing; when the second keyboard is disposed in the keyboard containing portion, the third connecting portion of the second keyboard is electrically connected to the first connecting portion, so that the user can use the second keyboard to play e-sports games. Furthermore, by exchanging the first keyboard and the second keyboard according to different purposes, the portable electronic apparatus can be convenient to store and easy to carry.

### BRIEF DESCRIPTION OF THE DRAWINGS

FIG. 1 illustrates a schematic diagram of an embodiment of a portable electronic apparatus of the present invention;

FIG. 2A and 2B illustrate block diagrams of the portable electronic apparatus shown in FIG. 1;

FIG. 3 illustrates a schematic diagram of the operation of the first keyboard shown in FIG. 1 being separated from the base casing;

FIG. 4 illustrates a schematic diagram of the operation of replacing the first keyboard shown in FIG. 3 with the second keyboard;

FIG. 5 illustrates a schematic diagram of the second keyboard shown in FIG. 4 being placed in the base casing;

FIG. 6 illustrates a schematic diagram of another embodiment of the portable electronic apparatus of the present invention; and

FIG. 7A and FIG. 7B illustrate schematic diagrams of an embodiment of an expansion element of the portable electronic apparatus of the present invention.

### DETAILED DESCRIPTION OF THE PREFERRED EMBODIMENT

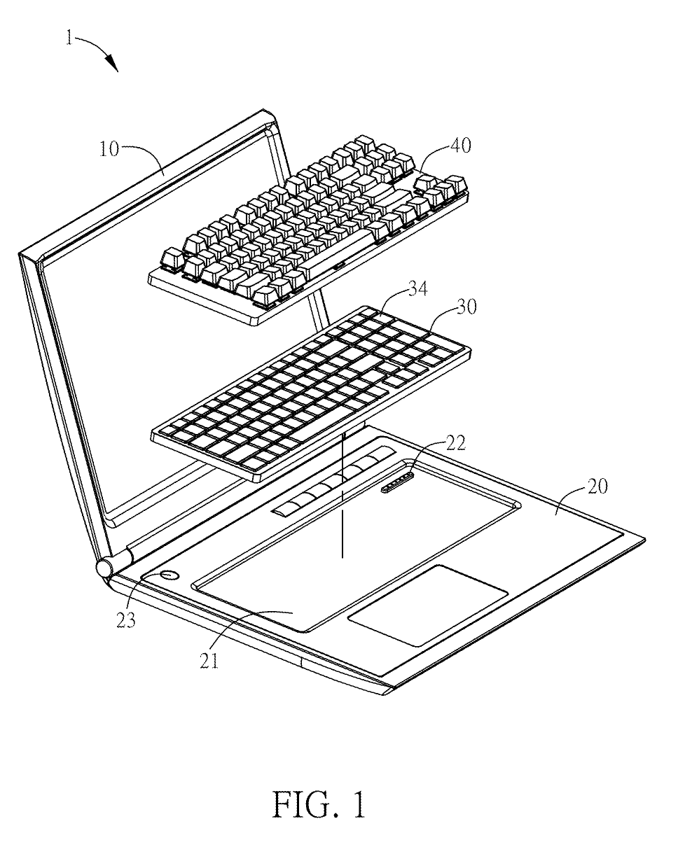

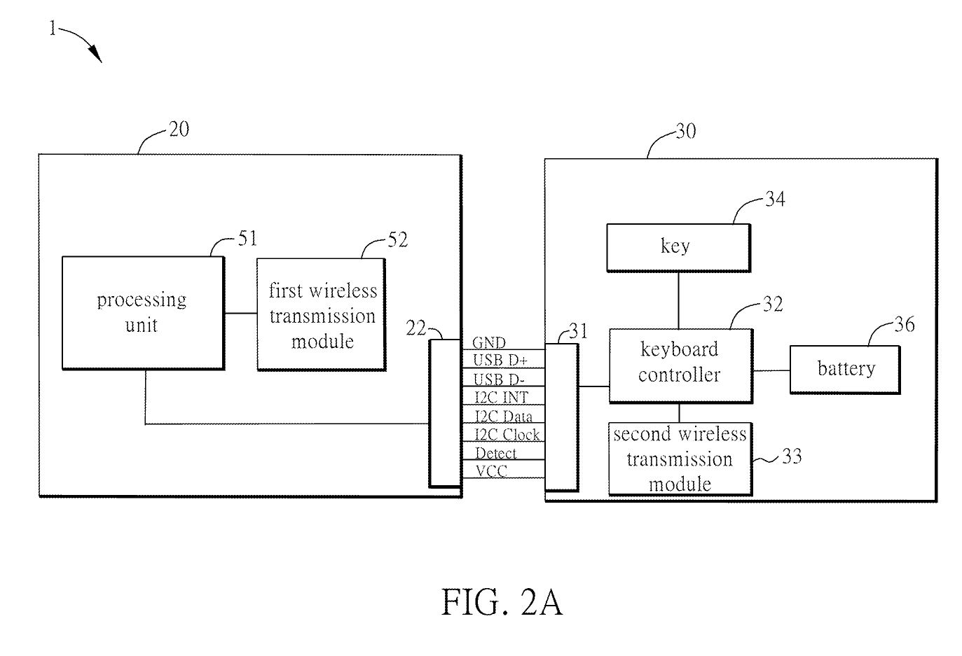

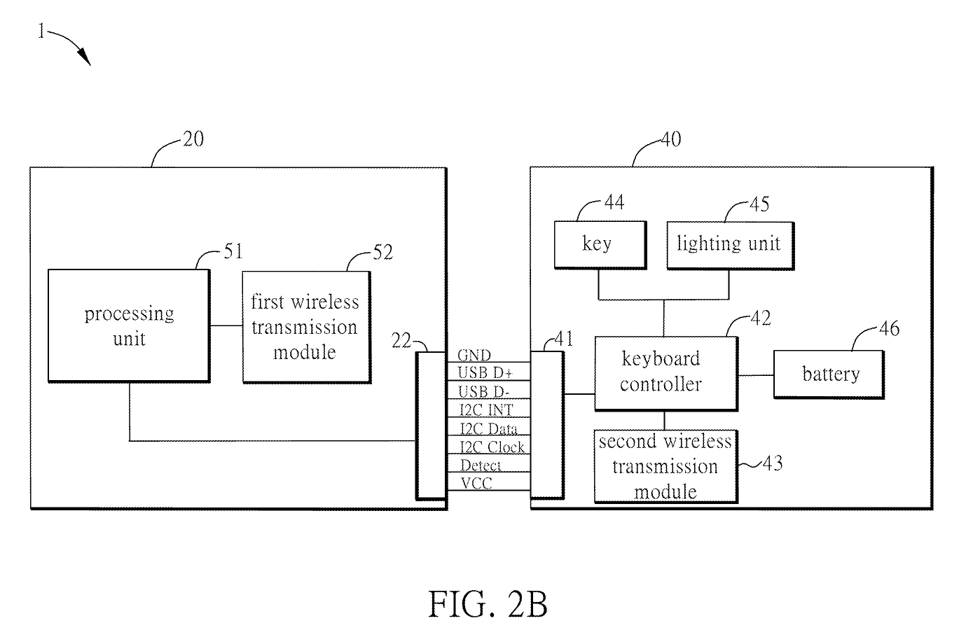

For better understanding of the technical features of the present invention, preferred embodiments are described below. Please refer to FIG. 1, FIG. 2A and FIG. 2B at the same time, wherein FIG. 1 illustrates a schematic diagram of an embodiment of a portable electronic apparatus of the present invention; FIG. 2A and 2B illustrate block diagrams of the portable electronic apparatus shown in FIG. 1. FIG. 2A illustrates a state in which a first keyboard 30 is disposed in a keyboard containing portion 21, and FIG. 2B illustrates a state in which the second keyboard 40 is disposed in the keyboard containing portion 21. The portable electronic apparatus 1 of this embodiment comprises a cover casing 10, a base casing 20, a first keyboard 30, and a second keyboard 40. The portable electronic apparatus 1 of this embodiment is a notebook computer, and has the cover casing 10 and the base casing 20, wherein the base casing 20 is pivotally connected to the cover casing 10, that is, the cover casing 10 and the base casing 20 are pivotally connected to each other, thereby allowing the cover casing 10 to be opened or closed with respect to the base casing 20. In this embodiment, the cover casing 10 is a display screen, and the base casing 20 is a base for accommodating a keyboard (such as the first keyboard 30 and the second keyboard 40 of the present embodiment) and main electronic components.

The base casing 20 comprises a keyboard containing portion 21. In this embodiment, the keyboard containing portion 21 may be a recess for the first keyboard 30 and the second keyboard 40 to be disposed in the keyboard containing portion 21 interchangeably. The first keyboard 30 of this embodiment uses a membrane keyboard as an example, and the second keyboard 40 uses a gaming mechanical keyboard as an example. When the user is using the portable electronic apparatus 1 for document processing, the first keyboard 30 may be disposed in the keyboard containing portion 21, and when the user is playing an e-sports game, the first keyboard 30 is replaced with the second keyboard 40, that is, the second keyboard 40 is disposed in the keyboard containing portion 21, and the first keyboard 30 and the second keyboard 40 are exchanged according to different purposes. The present invention can have any number of keyboards, that is, the portable electronic apparatus 1 can have not only the first keyboard 30 and the second keyboard 40, but also other types of keyboards. The manufacturers of notebook computers or keyboards can design other types of dedicated keyboards for users to replace and use according to different purposes and requirements.

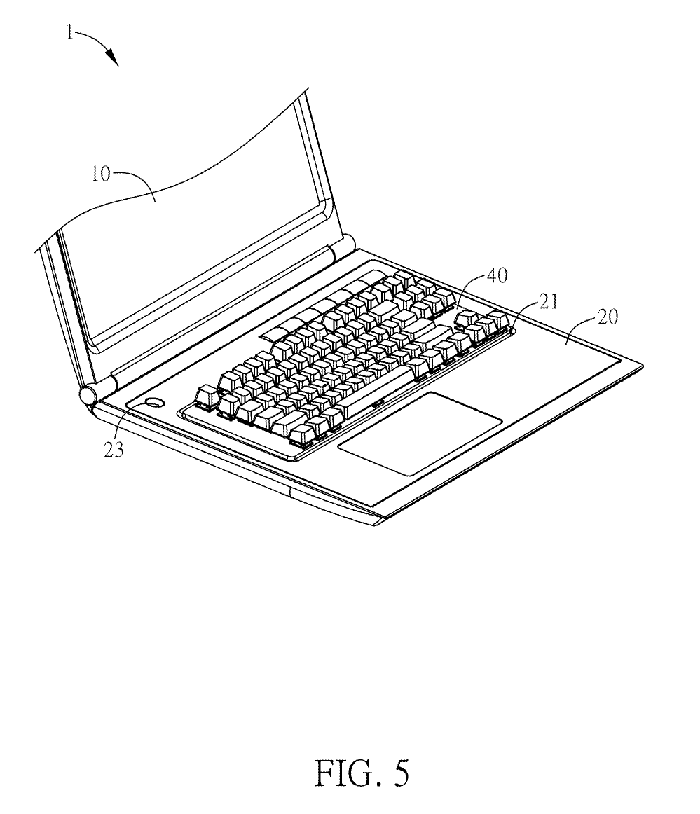

Specifically, the base casing 20 comprises a first connecting portion 22 disposed in the keyboard containing portion 21. In addition, the first keyboard 30 has a second connecting portion 31, and the second keyboard 40 has a third connecting portion 41. In this embodiment, the first connecting portion 22 is located on a surface of the keyboard containing portion 21, correspondingly, the second connecting portion 31 is located on the bottom surface of the first keyboard 30, and the third connecting portion 41 is also located on the bottom surface of the second keyboard 40 (the third connecting portion 41 is shown in FIG. 5, the second connecting portion 31 has the same configuration as that of the third connecting portion 41).

When the first keyboard 30 is disposed in the keyboard containing portion 21, the second connecting portion 31 is electrically connected to the first connecting portion 22. The first connecting portion 22 is electrically connected to the second connecting portion 31 to transmit the sensing signal or trigger signal received by the first keyboard 30 to the processing unit 51 of the portable electronic apparatus 1, as shown in FIG. 2A. In addition, when the second keyboard 40 is disposed in the keyboard containing portion 21, the third connecting portion 41 is electrically connected to the first connecting portion 22 to transmit the sensing signal or trigger signal received by the second keyboard 40 to the processing unit 51 of the portable electronic apparatus 1, as shown in FIG. 2B.

In this embodiment, the first keyboard 30 comprises a keyboard controller 32, which is electrically connected to the second connecting portion 31. The portable electronic apparatus 1 further comprises the processing unit 51 disposed in the base casing 20 and electrically connected to the first connecting portion 22. The keyboard controller 32 is provided for determining whether a key 34 of the first keyboard 30 is pressed and processing the data input from the pressed key 34 to output a signal. In this embodiment, the second connecting portion 31 and the first connecting portion 22 are used for transmitting the output signal to the processing unit 51. The processing unit 51 determines and executes an instruction or an execution mode corresponding to the output signal (for example, the processing unit 51 determines which one of the first keyboard 30 and the second keyboard 40 is in use). In this embodiment, the processing unit 51 can be a central processing unit of the portable electronic apparatus 1 or a processing circuit with other special functions, in other words, the processing unit 51 of this embodiment can be any processing circuit with computing capability.

Preferably, the portable electronic apparatus 1 further comprises a first wireless transmission module 52 disposed in the base casing 20 and electrically connected to the processing unit 51. The first keyboard 30 further comprises a second wireless transmission module 33 electrically connected to the keyboard controller 32. When the second connecting portion 31 is electrically connected to the first connecting portion 22, the second connecting portion 31 is used for communicating with the first connecting portion 22; when the second connecting portion 31 is electrically separated from the first connecting portion 22, the first wireless transmission module 52 and the second wireless transmission module 33 can be coupled to each other for data/signal transmission.

It is also noted that, as shown in FIG. 2B, the second keyboard 40 of this embodiment also comprises a keyboard controller 42 and a second wireless transmission module 43, wherein the keyboard controller 42 and the second wireless transmission module 43 are electrically connected to each other, and the keyboard controller 42 is electrically connected to the third connecting portion 41, so that the second keyboard can be wired or wirelessly connected to the processing unit 51 for data/signal transmission. Similarly, when the third connecting portion 41 is electrically separated from the first connecting portion 22, the first wireless transmission module 52 and the second wireless transmission module 43 can be coupled to each other for data/signal transmission.

In other embodiments, the first connecting portion 22 can be located at other positions in the keyboard containing portion 21 as long as the position corresponds to those of the second connecting portion 31 and the third connecting portion 41. For example, the first connecting portion 22 can be disposed on the inner side wall of the keyboard containing portion 21, and the second connecting portion 31 is correspondingly disposed on the side wall of the first keyboard 30. Similarly, the third connecting portion 41 is correspondingly disposed on the side wall of the second keyboard 40. When the first keyboard 30 or the second keyboard 40 is disposed in the keyboard containing portion 21, the second connecting portion 31 or the third connecting portion 41 can be electrically connected to the first connecting portion 22 for data/signal transmission.

In this embodiment, the second connecting portion 31 is the same member as the third connecting portion 41, and the first connecting portion 22 and the second connecting portion 31 are a set of male and female connectors, the first connecting portion 22 and the third connecting portion 41 are also a set of male and female connectors. Specifically, the first connecting portion 22 can be a connector plug; correspondingly, the second connecting portion 31 and the third connecting portion 41 are connector sockets. The first connecting portion 22, the second connecting portion 31 and the third connecting portion 41 can be connectors consisted of universal serial bus (USB), inter-integrated circuit (I²C), serial peripheral interface (SPI), universal asynchronous receiver-transmitter (UART) or any specific pins, or any other connector devices. In this embodiment, the first connecting portion 22, the second connecting portion 31 and the third connecting portion 41 can be pogo pin connectors consisted of USB and I²C interfaces. In addition, the first connecting portion 22 has a single pin type spring (such as pogo pin), the second connecting portion 31 and third connecting portion 41 have metal spring plates, wherein the single pin type spring and metal spring plates are electrically connected for signal transmission, and the universal serial bus (USB) and inter-integrated circuit (I²C) are used for controlling the first keyboard 30 or the second keyboard 40.

For example, gaming keyboard (second keyboard 40) generally has a lighting unit 45 corresponding to each key, and the gaming keyboard can use the universal serial bus (USB) and inter-integrated circuit (I²C) to control the lighting unit, as shown in FIG. 2B. For example, the pogo pin connector can be consisted of GND, USB D+, USB D−, I²C INT, I²C Data, I²C Clock, Detect, VCC and other pins. Among them, the power pin VCC and the ground pin GND can be used for power connection; the data pin USB D+, USB D− can be used for data transmission and controlling the lighting unit 45; the input pin I²C INT can be used for waking up the portable electronic apparatus 1 when the key 44 (Or the key 34) is pressed; the input pins I²C Data, I²C Clock can be used for initialization setting; and the detection pin Detect can be used to detect the connection with the first keyboard 30 or the second keyboard 40.

Preferably, the first keyboard 30 comprises a battery 36 for providing power. When the second connecting portion 31 is electrically connected to the first connecting portion 22, the detecting pin Detect detects the connection with the first keyboard 30, the base casing 20 provides power to the first keyboard 30, and the second connecting portion 31 is used for communicating with the first connecting portion 22. When the second connecting portion 31 is electrically separated from the first connecting portion 22, the first keyboard 30 is now powered by the battery 36, and automatically switches to the state of the first wireless transmission module 52 and the second wireless transmission module 33 coupled to each other to provide data/signal transmission, so that the first keyboard 30 can be used separately from the base casing 20. The second keyboard 40 can have the same configuration as described above, which will not be described here for the sake of brevity.

Preferably, the base casing 20 can comprise a fixing structure (not shown in figure), which can be, for example but not limited to, a snap fastener, a clamping rod, or a slot, for fixing the first keyboard 30 or the second keyboard 40 in the keyboard containing portion 21. The first keyboard 30 and the second keyboard 40 can be designed according to the type and configuration of the fixing structure. For example, if the fixing structure is a snap fastener or a clamping rod, then a slot or a recess can be provided in the first keyboard 30 and the second keyboard 40 for holding the snap fastener or the clamping rod.

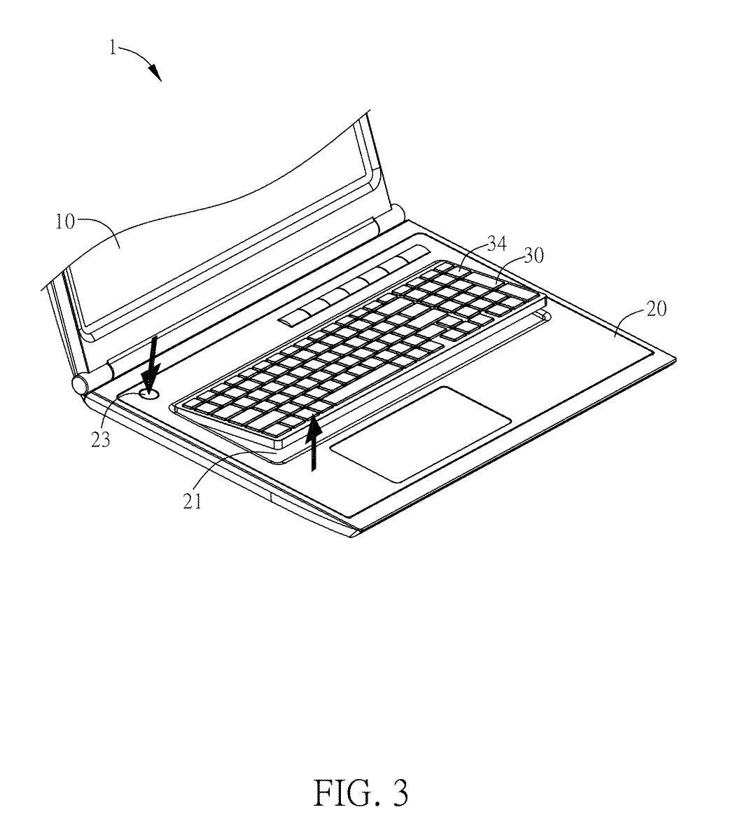

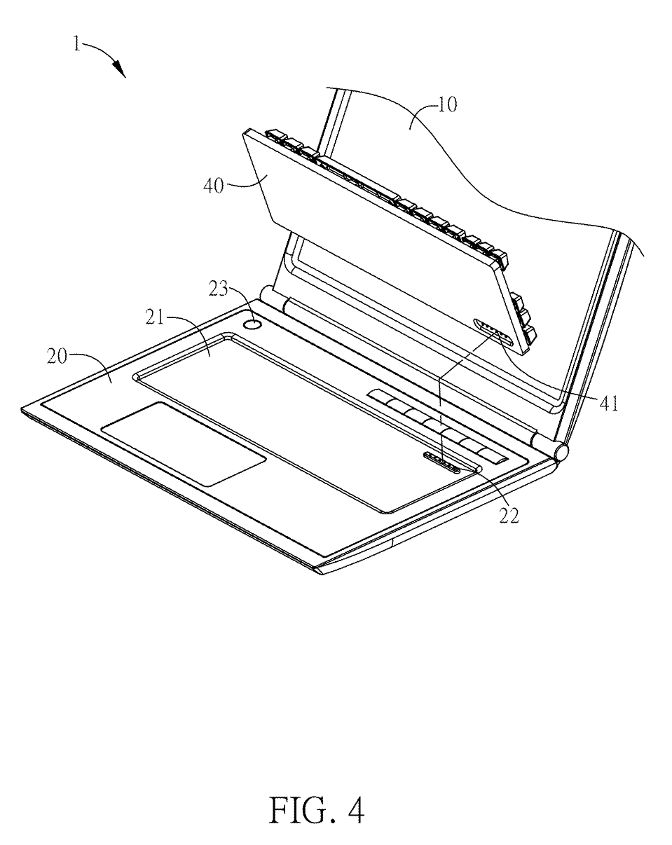

Preferably, the base casing 20 further comprises an eject switch 23 connected to the fixing structure. When a force is applied on the eject switch 23, for example, the user presses the eject switch 23, the eject switch 23 is released (loosed) from the fixing structure to eject the first keyboard 30 or the second keyboard 40 from the keyboard containing portion 21, as shown in FIG. 3. FIG. 3 illustrates a schematic diagram of the operation of the first keyboard shown in FIG. 1 being separated from the base casing. In addition, the eject switch 23 can have a connecting rod protruding from the keyboard containing portion 21, when the user presses the eject switch 23, the connecting rod is pressed against the first keyboard 30 or the second keyboard 40 to help disengage the first keyboard 30 or the second keyboard 40 from the keyboard containing portion 21. In FIG. 3, the first keyboard 30 is used as an example. After the first keyboard 30 is removed, the third connecting portion 41 of the second keyboard 40 can be disposed with respect to the first connecting portion 22 of the keyboard containing portion 21, as shown in FIG. 4. FIG. 4 illustrates a schematic diagram of the operation of replacing the first keyboard shown in FIG. 3 with the second keyboard. Then, the second keyboard 40 is disposed in the keyboard containing portion 21 to be the keyboard in use, as shown in FIG. 5. FIG. 5 illustrates a schematic diagram of the second keyboard shown in FIG. 4 being placed in the base casing.

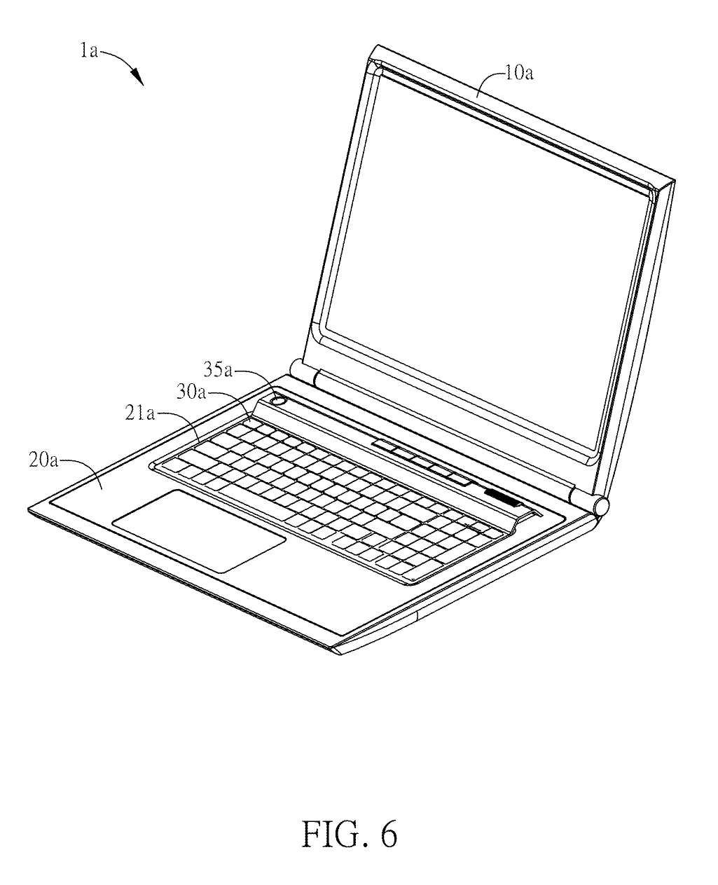

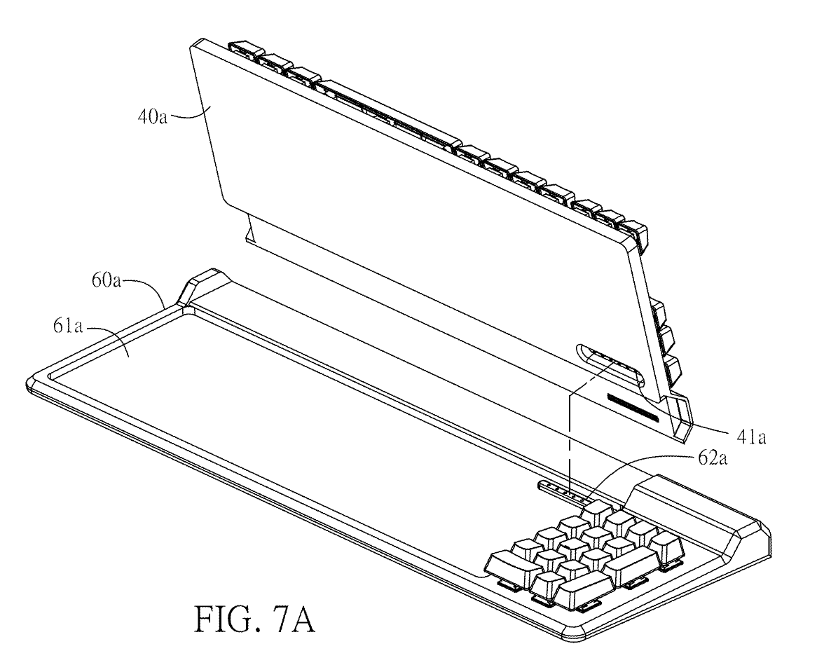

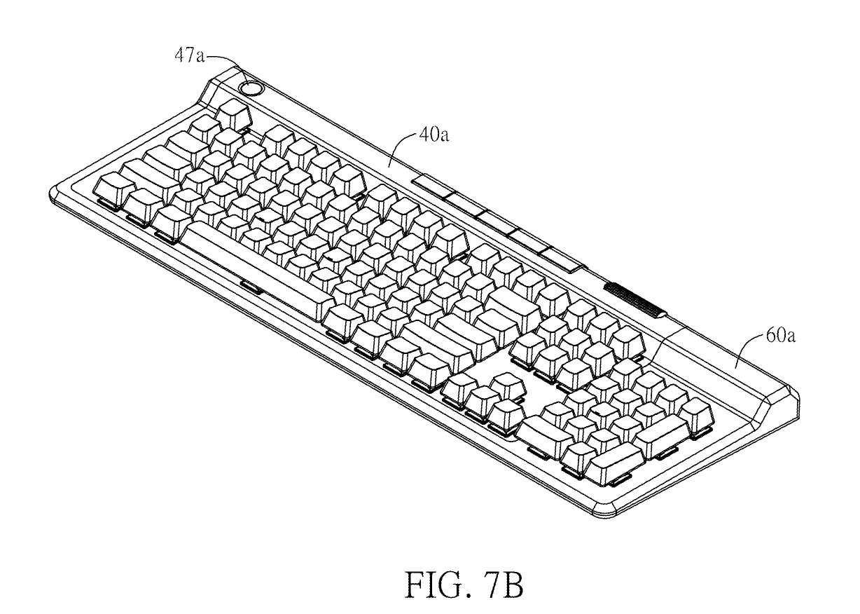

In other embodiments, the eject switch can be disposed at the first keyboard or the second keyboard, or any other suitable positions. Please refer to FIG. 6, which illustrates a schematic diagram of another embodiment of the portable electronic apparatus of the present invention. In this embodiment, the first keyboard 30a comprises an eject switch 35a, which can comprise a connecting rod projecting from the bottom surface of the first keyboard 30a. When the user presses the eject switch 35a to apply a force on the eject switch 35a, the connecting rod is pushed by the eject switch 35a to be pressed against the base casing 20a, thereby separating the first keyboard 30a from the keyboard containing portion 21a. Similarly, the second keyboard 40 can comprise an eject switch 47a (please refer to FIG. 7B), and the setting position and operation of the eject switch 47a may refer to those of the first keyboard 30a and the eject switch 35a and will not be described here.

Please refer to FIG. 6, FIG. 7A and FIG. 7B at the same time. FIG. 7A and FIG. 7B illustrate schematic diagrams of an embodiment of an expansion element of the portable electronic apparatus of the present invention. Preferably, the portable electronic apparatus 1a of this embodiment further comprises an expansion element 60a, which is an external keyboard socket and can be wired or wirelessly connected to the processing unit (such as the processing unit 51 shown in FIG. 2A and 2B) of the portable electronic apparatus 1a. In addition, the expansion element 60a comprises a sub keyboard containing portion 61a and a fourth connecting portion 62a, wherein the fourth connecting portion 62a is located in the sub keyboard containing portion 61a. The sub keyboard containing portion 61a is the same member as the keyboard containing portion 21a, both are provided for disposing the first keyboard 30a or the second keyboard 40a. In FIG. 7A and FIG. 7B, the second keyboard 40a is used as an example. The third connecting portion 41a of this embodiment is located on the bottom surface of the second keyboard 40a, and the fourth connecting portion 62a is located on a surface of the sub keyboard containing portion 61a.

In addition, the fourth connecting portion fourth 62a is the same member as the first connecting portion 22 (refer to the first connecting portion 22 shown in FIG. 1), that is, it can be a pogo pin connector to be connected to the third connecting portion 41b of the metal spring plate. When the second keyboard 40a is disposed in the sub keyboard containing portion 61a, the third connecting portion 41a is electrically connected to the fourth connecting portion 62a, and the expansion element 60a is formed as an external keyboard, which acts as an external e-sports gaming keyboard to facilitate better operation experience for the user in playing e-sports games.

In FIG. 7A and FIG. 7B, the second keyboard 40a is used as an example. Similarly, the first keyboard 30a can be disposed in the sub keyboard containing portion 61a interchangeably. When the first keyboard 30a is disposed in the sub keyboard containing portion 61a, the second connecting portion of the first keyboard 30a is connected to the fourth connecting portion 62a, so that the expansion element 60a is formed as an external keyboard to facilitate user input.

When the first keyboard 30 is disposed in the keyboard containing portion 21, the second connecting portion 31 is electrically connected to the first connecting portion 22. The first connecting portion 22 is electrically connected to the second connecting portion 31 to transmit the sensing signal or trigger signal received by the first keyboard 30 to the processing unit 51 of the portable electronic apparatus 1, as shown in FIG. 2A. In addition, when the second keyboard 40 is disposed in the keyboard containing portion 21, the third connecting portion 41 is electrically connected to the first connecting portion 22 to transmit the sensing signal or trigger signal received by the second keyboard 40 to the processing unit 51 of the portable electronic apparatus 1, as shown in FIG. 2B.

As described above, the portable electronic apparatus of the present invention comprises the first keyboard and the second keyboard, and the base casing of the portable electronic apparatus comprises the keyboard containing portion and the first connecting portion for the first keyboard and the second keyboard to be disposed in the keyboard containing portion interchangeable to perform different functions respectively, thereby allowing the portable electronic apparatus to provide various types of keyboard inputs, and to be applicable to different purposes. For example, when the first keyboard is disposed in the keyboard containing portion, the second connecting portion of the first keyboard is electrically connected to the first connecting portion so that the user can use the first keyboard to perform document processing; when the second keyboard is disposed in the keyboard containing portion, the third connecting portion of the second keyboard is electrically connected to the first connecting portion, so that the user can use the second keyboard to play e-sports games. Furthermore, by exchanging the first keyboard and the second keyboard according to different purposes, the portable electronic apparatus can be convenient to store and easy to carry.

From the foregoing description, regardless of the objects, the techniques, the effects or the skill aspects and developments, the present invention is distinctive with respect to known skills. Although the present invention has been explained in relation to its preferred embodiment, it is to be understood that many other possible modifications are variations can be made without departing from the scope of the invention as hereinafter claimed.

What is claimed is:

1. A portable electronic apparatus comprising:
a cover casing;
a base casing pivoted to the cover casing, the base casing comprising a keyboard containing portion and a first connecting portion, wherein the first connecting portion is disposed in the keyboard containing portion; and
a first keyboard and a second keyboard being disposed in the keyboard containing portion interchangeably, the first keyboard having a second connecting portion, and the second keyboard having a third connecting portion;
when the first keyboard is disposed in the keyboard containing portion, the second connecting portion is electrically connected to the first connecting portion, when the second keyboard is disposed in the keyboard containing portion, the third connecting portion is electrically connected to the first connecting portion.

2. The portable electronic apparatus as claimed in claim 1, wherein the second connecting portion is the same member as the third connecting portion.

3. The portable electronic apparatus as claimed in claim 2, wherein the first connecting portion, the second connecting portion and the third connecting portion are respectively pogo pin connectors.

4. The portable electronic apparatus as claimed in claim 3, wherein the first connecting portion has a single pin type spring, the second connecting portion and the third connecting portion each have a metal spring plate.

5. The portable electronic apparatus as claimed in claim 2, wherein the second connecting portion and the third connecting portion each comprise a power pin, a ground pin, a plurality of data pins, a plurality of input pins, and a detection pin.

6. The portable electronic apparatus as claimed in claim 2, wherein the base casing further comprises an eject switch, when a force is applied on the eject switch, the eject switch ejects the first keyboard or the second keyboard from the keyboard containing portion.

7. The portable electronic apparatus as claimed in claim 2, wherein the first keyboard and the second keyboard each comprise an eject switch, when a force is applied on the eject switch, the eject switch ejects the first keyboard or the second keyboard from the keyboard containing portion.

8. The portable electronic apparatus as claimed in claim 2 further comprising:
an expansion element comprising a sub keyboard containing portion and a fourth connecting portion, wherein the fourth connecting portion is disposed in the sub keyboard containing portion, and the first keyboard and the second keyboard are disposed in the sub keyboard containing portion interchangeably, when the first keyboard is disposed in the sub keyboard containing portion, and the second connecting portion is electrically connected to the fourth connecting portion; when the second keyboard is disposed in the sub keyboard containing portion, the third connecting portion is electrically connected to the fourth connecting portion.

9. The portable electronic apparatus as claimed in claim 8, wherein the first connecting portion is the same member as the fourth connecting portion.

10. The portable electronic apparatus as claimed in claim 2, wherein the first keyboard is a membrane keyboard and the second keyboard is a gaming mechanical keyboard.

11. The portable electronic apparatus as claimed in claim 1, wherein the first connecting portion, the second connecting portion and the third connecting portion are consisted of a universal serial bus (USB) and an inter-integrated circuit (I²C).

12. The portable electronic apparatus as claimed in claim 11, wherein the second keyboard comprises keys having a plurality of lighting units, and the plurality of lighting units can be controlled by the universal serial bus (USB) or the inter-integrated circuit (I²C).

13. The portable electronic apparatus as claimed in claim 1, wherein the base casing is provided with a first wireless transmission module, the first keyboard or the second keyboard is provided with a second wireless transmission module, when the second connecting portion or the third connecting portion is electrically connected to the first connecting portion, the second connecting portion or the third connecting portion is used for communicating with the first connecting portion, when the second connecting portion or the third connecting portion is electrically separated from the first connecting portion, the first wireless transmission module is used for communicating with the second wireless transmission module.

14. The portable electronic apparatus as claimed in claim 1, wherein the first keyboard or the second keyboard is provided with a battery, when the second connection portion or the third connection portion is electrically separated from the first connection portion, the battery is used for providing power to the first keyboard or the second keyboard.
